(19) United States
(12) Patent Application Publication
(10) Pub. No.: US 2025/0294366 A1
(43) Pub. Date: Sep. 18, 2025

(54) COOPERATIVE SPECTRUM SENSING METHOD FOR COGNITIVE RADIO DEVICE

(71) Applicant: SAMSUNG ELETRÔNICA DA AMAZÔNIA LTDA., MANAUS, AM (BR)

(72) Inventor: JUSSIF JUNIOR ABULARACH ARNEZ, MANAUS (BR)

(73) Assignee: SAMSUNG ELETRÔNICA DA AMAZÔNIA LTDA., MANAUS, AM (BR)

(21) Appl. No.: 18/668,548

(22) Filed: May 20, 2024

(30) Foreign Application Priority Data
Mar. 15, 2024 (BR) 10 2024 005259 5

(51) Int. Cl. H04W 16/14

(52) U.S. Cl. CPC H04W 16/14

(57) ABSTRACT

The present invention relates to wireless mobile communication, digital signal processing as well as telecommunication engineering. An accuracy formulation method combining mobile users' capabilities and classic statistics theory as well as digital signal processing concepts is provided. The method is enabled to compute and provide a trade-off among baseband sampling, mobile user spectrum sensing duration time, probability to correctly detect an occupied channel and dynamic power consumption values considering the Analog to Digital Convertors (ADC) technical capabilities as a relation of the number of bits levels of resolution. In addition, probability of false alarm, i.e., the probability not to detect properly a vacant frequency, it is also computed.

### CROSS-REFERENCE TO RELATED APPLICATION(S)

This application is based on and claims priority under 35 U.S.C. § 119 to Brazilian Patent Application No. BR 10 2024 005259 5, filed on Mar. 15, 2024, in the Brazilian Intellectual Property Office, the disclosure of which is incorporated by reference herein in its entirety.

### TECHNICAL FIELD

The present invention relates to an accurate method combining mobile users' capabilities and classic statistics theory as well as digital signal processing concepts. The proposed method can compute and provide a trade-off among baseband sampling, mobile detection user sensing time, probability to correctly detect an occupied channel and power consumption values of the analog-to-digital converters (ADC) as a relation of the number of bits levels. To mitigate fading interference when mobile users are moving or any of the objects that provides a reflective surface, wherein the mobile users can be transmitters or receivers, the concept of Cooperative Spectrum Sensing (CSS) is applied.

In CSS networks, Cognitive Radio (CR) mobile users send their spectrum sensing (SS) local reports to a main database. The database applies algorithms to send back to CR mobile user the final decision to reutilize or not a vacant channel based on real-time measurements. Therefore, the technical field of the present invention is wireless mobile communication, more in detail related to the Fifth Generation (5G) and Beyond Fifth Generation (B5G) mobile networks since the main objective is that mobile users can reutilize the vacant frequency channels by optimizing radio spectrum usage.

### BACKGROUND OF THE INVENTION

The lack of available electromagnetic spectrum for mobile communication purposes has been an important obstacle since more wireless technologies are being deployed operating in overcrowded bands. The scarcity of useful frequency bands is due to the uniform distribution of the spectrum usage rather than a flexible spectrum approach.

A relevant application of CR and CSS paradigms is at Low frequencies and Lower-mid frequencies due to their coverage area and lower propagation loss, since propagation attenuation is inversely proportional to the square of a group of center frequency. Low frequencies and Lower-mid frequencies are located at 300 to 1000 MHz and 1000 MHz to 7000 MHz, respectively. These frequencies are the main interesting frequencies to deploy a CR mobile user network.

As mentioned before, along the deployment of mobile telecommunication generation there has been an increasing number of mobile users connected to mobile networks. There are approximately 5.32 billion unique mobile users in the world and a growing rate of 1.7% per year. In contrast, the electromagnetic spectrum is a finite resource and at-present is congested since its usage is not efficient.

With the aim of reusing vacant frequencies, the concepts of CR and CSS provide mobile users with the ability to make decisions on electromagnetic spectrum usage reports in real-time, to adjust their transmission power in order to ensure environmental propagation. Additionally, the radio electromagnetic spectrum as well as the SS results are shared with other CR devices (mobile users, wearables, tablets, IoT).

The purpose of the present invention is to provide an accurate formulation algorithm combining mobile users' capabilities and classic statistics theory, as well as digital signal processing concepts. The proposed method can compute and provide a trade-off among the baseband sampling fₛ), mobile user spectrum sensing duration time (t_{d}), probability to correctly detect an occupied channel (P_{d}) and dynamic power consumption values considering the ADC capabilities as a relation of the number of bits levels of resolution of the quantizer during the acquisition conversion stage.

The flexible use of radio spectrum trend currently used is to provide a real-time method that can offer lower power consumption and provide higher probability of detection (P_{d}), while reusing vacant frequencies making CR devices very reliable and energy efficient in energetic terms. That is, using less energy to perform the same task with the same result.

Most of the prior art documents do not consider an experimental real-time testbed and the approaches are solely theoretical, which do not include parameters, features, and limitation of a device or an equipment. Therefore, to solve these problems, the present invention relates to formulate a method comprising as accurate algorithm combining mobile users' capabilities and classic statistics theory as well as digital signal processing concepts.

The proposed method of the present invention can compute and provide a trade-off among baseband sampling, mobile user spectrum sensing time, probability to correctly detect an occupied channel, and dynamic power consumption values considering the ADC capabilities. All the aforementioned parameters are based on real-time testbed experimentation as well as its advantage, hardware limitation and features.

Patent document CN109039504B, entitled “COGNITIVE RADIO ENERGY EFFICIENCY POWER DISTRIBUTION METHOD BASED ON NON-ORTHOGONAL MULTIPLE ACCESS”, published on Nov. 10, 2020, by Chongqing University of Post and Telecommunications. Patent CN109039504B belongs to the technical field of mobile communication, and particularly relates to a cognitive radio energy efficiency optimization power distribution method based on non-orthogonal multiple access, which comprises the steps of determining the consumption rate of the maximum transmission power of a sub-channel according to the interference power constraint of each master user, and determining the consumption rate of the minimum transmission power of the sub-channel according to the service quality constraint of each multiplexed cognitive user; obtaining an energy efficiency optimization model by taking the maximum system energy efficiency as an optimization target and meeting the consumption rate of the maximum transmission power of the sub-channel and the minimum transmission power consumption rate; solving the power distribution coefficient of the cognitive user in the sub-channel based on the convex difference planning and normalization; converting the fractional programming problem into an equivalent convex problem by adopting charges cooper transformation, and solving the optimal power consumption in the sub-channel by utilizing a KKT condition and a Lagrange multiplier method; the invention ensures that the average energy efficiency performance is superior to the fractional order power distribution method on the premise of ensuring the service quality of the user and the system fairness.

Patent document CN107947878A, entitled “A KIND OF COGNITIVE RADIO POWER DISTRIBUTION METHOD BASED ON EFFICIENCY AND SPECTRUM EFFECT COMBINED OPTIMIZATION”, published on Jan. 19, 2021, by Jiangsu University of Technology. Patent CN107947878A discloses a kind of cognitive radio power distribution method based on efficiency and spectrum effect combined optimization, belong to wireless communication resources distribution technique field, include the following steps: 1st, cognitive user carries out frequency spectrum perception using Energy-aware method, obtains the detection probability and false-alarm probability of cognitive user; 2nd, under the constraint of cognitive user average emitted power, primary user's average interference power and detection probability thresholding, the Optimized model P1 of maximum efficiency and spectrum effect is established; 3rd, conversion optimal model P1 of equal value; 4th, optimal power contribution, maximum efficiency and maximum spectrum effect are solved, obtains optimal power allocation and maximum efficiency spectrum effect. The present invention carries out optimal detecting period and optimal power contribution in the case of the efficiency of cognitive user can be maximized while cognition network spectrum effect is met, optimal detecting period and the distribution of optimal power are carried out in the case of the spectrum effect that cognitive user can also be maximized while cognition network efficiency is met.

Patent document CN106788810B, entitled “WIRELESS ENERGY ACQUISITION AND DISTRIBUTION METHOD OF GREEN COGNITIVE RADIO”, published on Jun. 16, 2020, by Harbin Engineering University. Patent CN106788810B provides a wireless energy acquisition and distribution method of green cognitive radio. Firstly, a green cognitive radio wireless energy acquisition and distribution model is established. Secondly, a quantum gray wolf searching mechanism is designed, and the quantum position of the quantum gray wolf is updated through a quantum gray wolf searching method. And the wireless energy collection and distribution of the green cognitive radio are realized by using a quantum gray wolf search method. And then, mapping the obtained global optimal quantum position into a position according to the obtained global optimal quantum position, and using the position as a scheme for acquiring and distributing the wireless energy of the cognitive radio. The invention seeks the minimum energy consumption of the system under the condition of meeting the throughput required by the system, realizes the self-energy supply of the cognitive radio system through wireless energy transmission, acquisition, and distribution, further does not need additional energy to supply to the device, and can store energy to a certain extent.

Patent document U.S. Pat. No. 9,277,413B2, entitled “COOPERATIVE COGNITIVE RADIO SPECTRUM SENSING USING A HYBRID DATA-DECISION METHOD”, published on Mar. 1, 2016, by King Fahd University of Petroleum and Minerals. A spectrum sensing method for cognitive radio to detect spectrum holes in an environment of bandwidth scarcity is described in patent U.S. Pat. No. 9,277,413B2. The method comprises first receiving a wireless signal at a cognitive radio user, and then discovering the frequency edges of allocated frequency bands by using wavelet transform coefficients to detect discontinuities in the power spectral density of the received signal. After determining the allocated frequency bands, the method determines frequency band availability by detecting the in-band energy using a bi-threshold energy detector, where the energy detector makes hard decisions and soft decisions. Finally, a fusion center combines hard and soft decisions collected from a cooperative spectrum sensing network of cognitive radio users and makes a final decision using a hybrid of data fusion and decision fusion to determine the final decision regarding spectrum availability.

Patent document U.S. Pat. No. 9,144,083B2, entitled “COOPERATIVE SENSING SCHEDULING FOR ENERGY-EFFICIENT COGNITIVE RADIO NETWORKS”, published on Sep. 22, 2015, by The Hong Kong University of Science and Technology. Cooperative sensing scheduling and parameter designs are described, which can achieve improvements in energy efficiency in cognitive radio networks, for example. In addition, the disclosed subject matter describes an objective or reward function, or policy related to energy efficiency and considerations such as channel assignments sensing time that can maximize the objective function. The disclosed details enable various refinements and modifications according to system design and tradeoff considerations.

The article entitled “SDR COOPERATIVE SPECTRUM SENSING USING THE NON-OVERLAPPING WELCH METHOD”, published on Dec. 3, 2021, by Jussif J. Abularach Arnez et al. The purpose of the present work is to assess the performance of a Cognitive Radio (CR) scheme using both Matlab simulation program and Python programming language to present the results of measurements performed in a testbed implemented using Software Defined Radio (SDR) for a Cooperative Spectrum Sensing (CSS) scenario. The spectrum sensing method considers the Welch spectrum sensing approach as well as the parameters and operational characteristics of the software-defined radio (SDR) Universal Software Radio Peripheral (USRP) device. This modified Welch method provides more accurate spectrum sensing. In addition, the Non-Overlapping Welch and the dwell delay digital signal processing blocks were implemented in the testbed.

The article entitled “IMPLEMENTATION AND ANALYSIS OF ENERGY DETECTION-BASED SENSING USING USRP/SBX PLATFORM”, published on Oct. 6, 2014, by Joon Young Kim et al. The performance of a spectrum sensing algorithm is dependent on many factors such as total detection time, radio noise floor, and carrier frequency. In order to maximize detection capability, the radio platform for which the spectrum sensor is implemented must be sufficiently configurable. An appropriate platform to address such a problem is the Universal Software Radio Peripheral (USRP) with a SBX daughterboard as it is software configurable and capable of wideband reception over a broad range of carrier frequencies. Motivation for characterizing the sensing limits of the USRP/SBX radio was the DARPA Spectrum Challenge (DSC) cooperative event. The DSC cooperative event simulated the scenario where multiple users must share the same channel and each user is not supplied with prior information of strategies employed by the other users. Solutions to this problem typically include spectrum sensing. This article provides the data necessary to design energy detection-based spectrum sensing for the USRP/SBX radio. The sensing capability of the USRP/SBX radio is determined via analysis of the receiver noise floor with respect to carrier frequency, sample rate, and detection time. Performance of the energy detection function is stated in closed form and provided with respect to parameters of the detector.

Patent application document IN 202241007447A, entitled “A FRAMEWORK FOR COOPERATIVE SPECTRUM SENSING FOR OPTIMAL RESOURCE ALLOCATION GREEN TOWARDS COGNITIVE RADIO NETWORKS”, published on Mar. 4, 2022, by Towheed Sultana et al. This invention is meant for realizing a framework for cooperative spectrum sensing for optimal resource allocation towards green cognitive radio networks. The invention has mechanisms to ensure energy conservation for secondary users while performing spectrum sensing. An adaptive and iterative method is devised to have energy aware power allocation to realize green cognitive radio networks. The current invention focuses on the cooperative approach in energy efficiency where each SU is involved in making decisions and the consolidated decision is taken by the fusion center.

The article entitled “THE EFFECT OF ADC VERTICAL RESOLUTION ON THE PERFORMANCE OF AN ENERGY DETECTION ALGORITHM IN COGNITIVE RADIOS”, published on May 14, 2018, by D. Capriglione et al. The ADC stage is considered as an isolated factor of influence, by evaluating the performance worsening obtained for different resolutions of the quantizer. By comparing the obtained SNRs after ADC stage and their related performance with results achievable for the same SNRS, calculated by neglecting the effect of ADC, the authors claim to prove how ADC distortion effects degrade performance beyond the computable SNR and therefore they need to be carefully considered in sensing scheme design.

The article entitled “HYBRID PSO-GSA FOR ENERGY EFFICIENT SPECTRUM SENSING IN COGNITIVE RADIO NETWORK” published June 2020, by Geoffrey Eappen et al. modeled as non-convex optimization problem. To detect spectrum holes with improved energy utilization, this article proposes a novel hybridization of Particle Swarm Optimization (PSO) with the proposed novel hybridization of PSO and GSA, it is possible to achieve balanced trade-off between exploration and exploitation abilities of PSO-GSA algorithm. In addition to that, with the incorporation of mutation and crossover factor in the PSO-GSA, the proposed algorithm is efficiently able to detect the spectrum holes with the optimized values of transmission power, sensing bandwidth and power spectrum sensing.

The article entitled “DYNAMIC DUAL THRESHOLD COOPERATIVE SPECTRUM SENSING FOR COGNITIVE RADIO UNDER NOISE POWER UNCERTAINTY”, published on Jun. 3, 2019, by Runze Wan et al. Aiming at the problem of threshold mismatch of energy detectors under noise power uncertainty, a cooperative spectrum sensing method with dynamic dual threshold is proposed. Firstly, the utility function is defined with the objective of minimizing the error probability of spectrum sensing, and the optimum threshold of energy detector is derived. Secondly, in order to mitigate the influence derived from noise uncertainty, an effective dynamic dual threshold adjustment mechanism is presented, and the optimizing combinative fusion rule is discussed with the prerequisite of the minimum global error probability.

### SUMMARY

The present invention relates to wireless mobile communication, digital signal processing as well as telecommunication engineering. Concretely, the present invention proposes an accuracy formulation method combining mobile users' capabilities and classic statistics theory as well as digital signal processing concepts. The proposed method is able to compute and provide a trade-off among baseband sampling (fₛ), mobile user spectrum sensing duration time (t_{d}), probability to correctly detect an occupied channel (P_{d}) and dynamic power consumption values considering the Analog to Digital Convertors (ADC) technical capabilities as a relation of the number of bits levels of resolution i.e., 2ⁿ where n:number of bits. In addition, probability of false alarm (P_{f}) i.e., the probability not to detect properly a vacant frequency, it is also computed. The dynamic power consumption refers to the power consumption of a device due to signal activity or toggling (a signal that goes from zero to one according to minimum and maximum peaks).

The method offers results considering the power consumption of the ADC converter during the Spectrum Sensing stage of a Cognitive Radio (CR) device. The present invention allows a better analysis, once it shows the existence of a trade-off among the baseband sampling frequency (fₛ), mobile user spectrum sensing duration time (t_{d}) and the power consumption of the ADC as a function of the number of bits levels of resolution of the quantizer during the acquisition conversion stage. For instance, to obtain a higher probability to correctly detect an occupied channel (Pa) i.e. P_{d}>90%, there is a situational decision that involves increasing the power consumption or losing quality resolution of the analog signal to be sampled; this fact must be considered in order to provide an accuracy method for a CR scenario.

There are two basic phases to the internal operation of an ADC converter such an acquisition phase stage and a conversion stage. The acquisition phase stage starts with the sample-and-hold disconnects and then, the ADC conversion stage is connected. The increasing of power consumption occurs during the latter stage, once the former stage there is not internal circuit full operating hence, the values are neglected. Yet it is important to consider for the proper computation of spectrum sensing duration time (t_{d}) for both basic ADC stages. Numerical results show the dependency among the number of bits levels of resolution of the quantizer during the acquisition conversion stage, baseband sampling frequency (fₛ), mobile user spectrum sensing duration time (t_{d}) as well as probability to correctly detect an occupied channel (P_{d}).

Embodiments of the present invention are described in detail. Along with the deployment of mobile telecommunication generation there has been an increasing number of mobile users connected to mobile networks. There are approximately 5.32 billion mobile users in the world today and a growing rate that is 1.7 percent per year. In contrast to the electromagnetic spectrum which is a finite resource and at-present is congested since its usage is not efficient due to its inflexible regulatory policy. Consequently, the electromagnetic environment will be crowded with thousands of devices sharing unlicensed frequency bands at different places e.g., stadiums, theaters, concerts. Cognitive Radio (CR) as well as Cooperative Spectrum Sensing (CSS) concepts were introduced in the literature as mechanisms to apply awareness and adaptiveness to sense the electromagnetic spectrum and provide to mobile users the capability to take decisions in real-time considering the spectrum sensing reports to adjust its transmission power to ensure the environmental propagation and share the electromagnetic spectrum radio as well as the spectrum sensing results with others CR devices (mobile users, wearables, tablets, IoT) with the objective to reutilize vacant frequencies.

### BRIEF DESCRIPTION OF THE DRAWINGS

The objectives and advantages of the present invention will become clearer through the following detailed description of the example and non-limitative drawings.

FIG. 1 shows the power consumption in Watts as a function of the sampling rate values of a device according to an embodiment of the disclosure.

FIG. 2 illustrates the power consumption in Watts for a 10-bits ADC as function of the sampling rate values of a device and the detection time in milliseconds during the spectrum sensing stage according to an embodiment of the disclosure.

FIG. 3 presents the power consumption in Watts for an 18-bits ADC as function of the sampling rate values of a device and the detection time in milliseconds during the spectrum sensing stage according to an embodiment of the disclosure.

FIG. 4 shows the results for a 10-bit ADC and single spectrum sensing case for the probability of detection P_{d} as a function of detection time, number of bits of the quantizer and the sampling rate fₛ of a device according to an embodiment of the disclosure.

FIG. 5 shows the results for a 10-bit ADC and cooperative spectrum sensing case using three mobile users for the probability of detection P_{d} as a function of detection time, number of bits of the quantizer and the sampling rate fₛ of a device for the OR rule according to an embodiment of the disclosure.

FIG. 6 shows the results for a 10-bit ADC and cooperative spectrum sensing case using three mobile users for the probability of detection P_{d} as a function of detection time, number of bits of the quantizer and the sampling rate fₛ of a device for the AND rule according to an embodiment of the disclosure.

FIG. 7 shows the results for an 18-bit ADC and single spectrum sensing case for the probability of detection P_{d} as a function of detection time, number of bits of the quantizer and the sampling rate fₛ of a device according to an embodiment of the disclosure.

FIG. 8 shows the results for an 18-bit ADC and cooperative spectrum sensing case using three mobile users for the probability of detection P_{d} as a function of detection time, number of bits of the quantizer and the sampling rate fₛ of a device for the OR rule according to an embodiment of the disclosure.

FIG. 9 shows the results for an 18-bit ADC and cooperative spectrum sensing case using three mobile users for the probability of detection P_{d} as a function of detection time, number of bits of the quantizer and the sampling rate fs of a device for the AND rule according to an embodiment of the disclosure.

FIG. 10 compares the results between a 10-bit ADC and an 18-bit ADC considering a single spectrum sensing case for the probability of detection P_{d} as a function of detection time, number of bits of the quantizer and the sampling rate fₛ of a device according to an embodiment of the disclosure.

FIG. 11 compares the results between a 10-bit ADC and an 18-bit ADC considering a cooperative spectrum sensing case for the probability of detection P_{d} as a function of detection time, number of bits of the quantizer and the sampling rate fₛ of a device for OR rule according to an embodiment of the disclosure.

FIG. 12 compares the results between a 10-bit ADC and an 18-bit ADC considering a cooperative spectrum sensing case for the probability of detection P_{d} as a function of detection time, number of bits of the quantizer and the sampling rate fₛ of a device for AND rule according to an embodiment of the disclosure.

### DETAILED DESCRIPTION

The proposed method is able to compute and provide a trade-off among baseband sampling (fₛ), mobile user spectrum sensing duration time (t_{d}), probability to correctly detect an occupied channel (P_{d}) and dynamic power consumption values considering the ADC technical capabilities as a relation of the number of bits levels of resolution i.e., 2ⁿ where n:number of bits. In addition, probability of false alarm (P_{f}) i.e., the probability not to detect properly a vacant frequency, it is also computed. The dynamic power consumption refers to the power consumption of a device due to signal activity or toggling (a signal that goes from zero to one according to minimum and maximum peaks).

Energy Detection can be computed in both time and frequency domain, hence a received sample signal x[n] is expressed as follows:

$$x [ n ] = hs [ n ] + η [ n ]$$

wherein x[n] is the received signal, s[n] is the transmitted signal, h is the complex gain of the ideal channel, η is the AWGN noise and n is the sample index in the case of time-domain sensing or symbol index for the frequency domain case.

A system with R^{th} users that senses the spectrum to detect the presence of the licensed user is considered. The spectrum sensing problem can be formulated by the pair of hypotheses, vacant channel H₀ or occupied channel H₁:

$${H}_{0} : {x}_{r} ( n ) = {η}_{r} ( n ) ; 1 < n < 2 tw \qquad Eq . ( 1 )$$

$${H}_{1} : {x}_{r} ( n ) = {h}_{r} s ( n ) + {η}_{r} ( n ) ; 1 < n < 2 tw \qquad Eq . ( 2 )$$

wherein xᵣ(n) represents the received complex sample signal for the r^{th} users, s(n) is the sample of the transmitted signal (licensed user) at sampling instant

$${t}_{n} = \frac{n}{2 w} ,$$

ηᵣ(n) is the sample of the AWGN noise received by r^{th} CR user at sampling instant

$${t}_{n} = \frac{n}{2 w} .$$

Additionally, AWGN noise is modeling as a gaussian random process with zero mean and variance σ² i.e., N(0, σ²), hᵣ is the channel propagation gain between the CR user and the licensed user; considering a propagation channel without multipath fading i.e., hᵣ=0 for H₀; hᵣ=1 for H₁.

Factor 2tw corresponds to the total N number of samples of the signal with a bandwidth w evaluated for t seconds along the spectrum sensing stage. Therefore, m is a time-bandwidth factor, expressed as follows:

$$N = 2 tw = 2 m \qquad Eq . ( 3 )$$

The spectrum sensing is computed using a high number of received N samples, as expressed in Eq. (3). Therefore, the statistic test for each mobile user r is defined by using the energy of the received samples, i.e., xᵣ(n)=Vᵣ=Eᵣ, which is be able to statistical approximated by a gaussian random variable. Then, the sum of all these samples for each mobile user r can be computed by:

$${x}_{r} ( n ) = {V}_{r} = {E}_{r} = \frac{1}{N} {\sum }_{n = 1}^{N = 2 tw} {x ( n )}^{2} \begin{matrix}{>}^{{H}_{1}} \\ < {H}_{0}\end{matrix} λ \qquad Eq . ( 4 )$$

wherein λ corresponds to the threshold value to define is the interest channel correspond to Eq. (1) or Eq. (2).

In order to compute Eq. (4) is essential to define the statistics metrics of the energy detector which are:
probability to correctly detect an occupied channel (P_{d}) as a function of the dynamic power consumption values considering the ADC technical capabilities as a relation of the number of bits levels of resolution i.e., 2ⁿ where n:number of bits.
probability of false alarm (P_{f}) which is the probability not to detect properly a vacant frequency.
probability of miss detection (Pₘ) which is the probability not to detect properly an occupied frequency.
the threshold value A to define is the interest channel correspond to Eq. (1) or Eq. (2).

The Short-Time Fourier Transform consists basically in using the received N samples of the mobile user and applies to them a rectangular window i.e., w(n). HYPOTHESES H₀

Considering the Short-Time Fourier Transform and the time domain approach, Eq. (1) and Eq. (4), for each of the r mobile user:

$${x}_{r} ( n ) = {V}_{r} = {E}_{r} = \frac{1}{N} {\sum }_{n = 1}^{N = 2 t w} {\vert x ( n ) w ( n ) \vert}^{2} \qquad Eq . ( 5 )$$

Therefore, the variance of the expected value of the complex gaussian random variable, represented in phase and quadrature, i.e., x²(n)˜N(0, σ²) is:

$${x}^{2} ( n ) = E [ {\vert {x}_{n} \vert}^{2} ] = {σ}^{2}$$

Once it is known that the random variables are statistics independent, then, is possible to compute the mean of hypotheses H₀, as expressed by Eq. (6). For simplicity, the energy of the collected sample of the n-mobile user, i.e. Vᵣ=Eᵣ, can be defined as V=E.

$${x}_{r} ( n ) = V = E = \frac{1}{N} {\sum }_{n = 1}^{N = 2 t w} {\vert x ( n ) \vert}^{2} {\vert w ( n ) \vert}^{2} \qquad Eq . ( 6 )$$

$${x}_{r} ( n ) = V = E = \frac{1}{N} {\sum }_{n = 1}^{N = 2 t w} {σ}^{2} {\vert w ( n ) \vert}^{2}$$

$${x}_{r} ( n ) = V = E = \frac{1}{N} {σ}^{2} {\sum }_{n = 1}^{N = 2 t w} {\vert w ( n ) \vert}^{2}$$

$${x}_{r} ( n ) = V = E = \frac{1}{N} {σ}^{2} {E}_{w}$$

$${μ}_{h 0} = \frac{1}{N} {σ}^{2} {E}_{w}$$

Since, the mean power of the received signal for H₀ is equal to:

$${m}_{x} = {μ}_{h 0} = \frac{1}{N} {σ}^{2} {E}_{w}$$

Next step is the variance σₕ₀² computing for Ho. The noise variance is defined as:

$${{σ}_{η}}^{2} = E [ {( x - {m}_{x} )}^{2} ] = E [ {x}^{2} ] - 2 {m}_{x} E [ x ] + {m}_{x}^{2} \qquad Eq . ( 7 )$$

$${{σ}_{η}}^{2} = E [ {x}^{2} ] - {m}_{x}^{2} = E [ {V}^{2} ] - {m}_{x}^{2}$$

Each sample of noise is defined as:

$${x}_{r} ( n ) = V = E = \frac{1}{N} {\sum }_{n = 1}^{N = 2 tw} {\vert x ( n ) w ( n ) \vert}^{2}$$

Considering Eq. (7),

$${x}_{r}^{2} ( n ) = V = E = {( \frac{1}{N} {\sum }_{n = 1}^{N = 2 tw} {\vert x ( n ) w ( n ) \vert}^{2} )}^{2}$$

$${x}_{r}^{2} ( n ) = V = E = \frac{1}{{N}^{2}} {\sum }_{{n}_{1 = 1}}^{N = 2 tw} {\sum }_{{n}_{2 = 1}}^{N = 2 tw} {\vert x ( {n}_{1} ) w ( {n}_{1} ) \vert}^{2} {\vert x ( {n}_{2} ) w ( {n}_{2} ) \vert}^{2}$$

$${x}_{r}^{2} ( n ) = V = E = \frac{1}{{N}^{2}} {\sum }_{{n}_{1 = 1}}^{N = 2 tw} {\sum }_{{n}_{2 = 1}}^{N = 2 tw} {\vert x ( {n}_{1} ) \vert}^{2} {\vert w ( {n}_{1} ) \vert}^{2} {\vert x ( {n}_{2} ) \vert}^{2} {\vert w ( {n}_{2} ) \vert}^{2}$$

Variable x²(n) can also be expressed as x²(n)=x(n)x*(n)

$${x}_{r}^{2} ( n ) = V = E = \frac{1}{{N}^{2}} {\sum }_{{n}_{1 = 1}}^{N = 2 tw} {\sum }_{{n}_{2 = 1}}^{N = 2 tw} E [ x ( {n}_{1} ) {x}^{*} ( {n}_{1} ) w ( {n}_{1} ) {w}^{*} ( {n}_{1} ) ] E [ x ( {n}_{2} ) {x}^{*} ( {n}_{2} ) w ( {n}_{2} ) {w}^{*} ( {n}_{2} ) ]$$

$${x}_{r}^{2} ( n ) = V = E = \frac{1}{{N}^{2}} {\sum }_{{i}_{1 = 1}}^{N = 2 tw} {\sum }_{{i}_{2 = 1}}^{N = 2 tw} ( E [ x ( {n}_{1} ) {x}^{*} ( {n}_{1} ) w ( {n}_{1} ) {w}^{*} ( {n}_{1} ) ] E [ x ( {n}_{2} ) {x}^{*} ( {n}_{2} ) w ( {n}_{2} ) {w}^{*} ( {n}_{2} ) ] + E [ x ( {n}_{1} ) {x}^{*} ( {n}_{2} ) w ( {n}_{1} ) {w}^{*} ( {n}_{2} ) ] E [ x ( {n}_{2} ) {x}^{*} ( {n}_{1} ) w ( {n}_{2} ) {w}^{*} ( {n}_{1} ) ] )$$

By solving the above expression, the result obtained is:

$${x}_{r}^{2} ( n ) = V = E = \frac{1}{{N}^{2}} ( {( {σ}^{2} )}^{2} {{E}_{w}}^{2} + {( {σ}^{2} )}^{2} {{E}_{w}}^{2} ) \qquad Eq . ( 8 )$$

$${x}_{r}^{2} ( n ) = V = E = 2 \frac{{( {σ}^{2} )}^{2} {{E}_{w}}^{2}}{{N}^{2}}$$

Considering Eq. (3), Eq. (7) and Eq. (8), the variance of the received signal by a mobile user for hypotheses H₀ is given by:

$${{σ}_{h 0}}^{2} = E [ {x}^{2} ] - {m}_{x}^{2} = E [ {V}^{2} ] - {m}_{x}^{2} \qquad Eq . ( 9 )$$

$${{σ}_{h 0}}^{2} = 2 \frac{{( {σ}^{2} )}^{2} {{E}_{w}}^{2}}{{N}^{2}} - {( \frac{1}{N} {σ}^{2} {E}_{w} )}^{2}$$

$${{σ}_{h 0}}^{2} = \frac{{( {σ}^{2} )}^{2} {{E}_{w}}^{2}}{{N}^{2}}$$

By using Eq. (9), is possible to compute the standard deviation for hypotheses H₀, i.e. σₕ₀, as follows:

$${σ}_{h 0} = \sqrt{{{σ}_{h 0}}^{2}} \qquad Eq . ( 10 )$$

$${σ}_{h 0} = \frac{{{σ}_{η}}^{2} {E}_{w}}{N}$$

Considering Eq. (6) and Eq. (9), the number of spectrum sensing procedures L of the interest channel can also be computed as follows:

$${T}_{r} = {x}_{r} ( n ) = V = E = \frac{1}{N} {\sum }_{n = 1}^{N = 2 tw} {\vert x ( n ) w ( n ) \vert}^{2} \qquad Eq . ( 11 )$$

$${T}_{r} = V = E = \frac{1}{L} {\sum }_{m = 1}^{L} {T}_{m}$$

From Eq. (11), if the algorithm of spectrum sensing increases the number of spectrums sensing L of the interest channel, the variance for the hypotheses H₀ decreases as function of the L factor. Then, considering Eq. (9):

$${{σ}_{h 0}}^{2} = \frac{{( {σ}_{η}^{2} )}^{2} {{E}_{w}}^{2}}{{N}^{2}} * \frac{1}{L} \qquad Eq . ( 12 )$$

### Hypotheses H₁

Considering the Short-Time Fourier Transform and the time domain approach, Eq. (2) and Eq. (4), for each of the r mobile user:

$${x}_{r} ( n ) = {V}_{r} = {E}_{r} = \frac{1}{N} {\sum }_{n = 1}^{N = 2 tw} {\vert x ( n ) w ( n ) \vert}^{2}$$

It is known that the random variables are statistics independent, then is possible to compute the mean of hypotheses H₁, as expressed by Eq. (13), as follows:

$${x}_{r} ( n ) = V = E = \frac{1}{N} {\sum }_{n = 1}^{N = 2 tw} {( h ( n ) s ( n ) w ( n ) + η ( n ) w ( n ) )}^{2}$$

$${x}_{r} ( n ) = V = E = \frac{1}{N} {\sum }_{n = 1}^{N = 2 tw} ( h ( n ) s ( n ) w ( n ) + n ( n ) w ( n ) ) {( h ( n ) s ( n ) w ( n ) + η ( n ) w ( n ) )}^{*}$$

$${x}_{r} ( n ) = V = E = \frac{1}{N} {\sum }_{i = 1}^{N = 2 tw} ( h ( n ) s ( n ) w ( n ) + n ( n ) w ( n ) ) ( {h}^{*} ( n ) {s}^{*} ( n ) {w}^{*} ( n ) + {η}^{*} ( n ) {w}^{*} ( n ) )$$

$${x}_{r} ( n ) = V = E = \frac{1}{N} {\sum }_{n = 1}^{N = 2 tw} {( h ( n ) s ( n ) w ( n ) )}^{2} + h ( n ) s ( i ) {η}^{*} ( n ) w ( n ) {w}^{*} ( n ) + {h}^{*} ( n ) {s}^{*} ( n ) η ( n ) w ( n ) {w}^{*} ( n ) + {( w ( n ) η ( n ) )}^{2}$$

Since the random variables are statistics independent, then:

$${x}_{r} ( n ) = V = E = \frac{1}{N} {\sum }_{n = 1}^{N = 2 tw} ( {h}^{2} {s ( n )}^{2} {w ( n )}^{2} + {w ( n )}^{2} {( η ( n ) )}^{2} ) \qquad Eq . ( 13 )$$

$${x}_{r} ( n ) = V = E = \frac{1}{N} {\sum }_{n = 1}^{N = 2 tw} ( {h}^{2} {w ( n )}^{2} {σ}_{s}^{2} + {w ( n )}^{2} {σ}_{η}^{2} )$$

$${x}_{r} ( n ) = V = E = \frac{1}{N} {\sum }_{n = 1}^{N = 2 tw} {w ( n )}^{2} ( {h}^{2} {σ}_{s}^{2} + {σ}_{η}^{2} )$$

$${x}_{r} ( n ) = V = E = \frac{1}{N} ( {h}^{2} {σ}_{s}^{2} + {σ}_{η}^{2} ) {\sum }_{n = 1}^{N = 2 tw} {w ( n )}^{2}$$

$${x}_{r} ( n ) = V = E = \frac{1}{N} ( {h}^{2} {σ}_{s}^{2} + {σ}_{η}^{2} ) {E}_{w}$$

$${x}_{r} ( n ) = V = E = \frac{{E}_{w}}{N} {σ}_{η}^{2} ( {h}^{2} \frac{{σ}_{s}^{2}}{{σ}_{η}^{2}} + 1 )$$

$${μ}_{h 1} = \frac{{E}_{w}}{N} {σ}_{η}^{2} ( {h}^{2} γ + 1 )$$

$${μ}_{h 1} = \frac{{E}_{w}}{N} {σ}_{η}^{2} ( γ + 1 )$$

The relation between the power of the signal and noise for a propagation channel, without neither any type of interference nor fading, is given by:

$$γ = \frac{{σ}_{s}^{2}}{{σ}_{η}^{2}} \qquad Eq . ( 14 )$$

Next step is the computation of the variance σₕ₁² for H₁, as follows:

$${x}_{r} ( n ) = V = E = \frac{1}{N} {\sum }_{n = 1}^{N = 2 tw} {( {( ( h ( n ) s ( n ) w ( n ) + η ( n ) w ( n ) ) )}^{2} )}^{2}$$

$${T}_{r} = {x}_{r} ( n ) = V = E = \frac{1}{{N}^{2}} {\sum }_{{n}_{1} = 1}^{N = 2 tw} {\sum }_{{n}_{2} = 1}^{N = 2 tw} {( ( h ( {n}_{1} ) s ( {n}_{1} ) w ( {n}_{1} ) + η ( {n}_{1} ) w ( {n}_{1} ) ) ( {h}^{*} ( {n}_{1} ) {w}^{*} ( {n}_{1} ) {s}^{*} ( {n}_{1} ) + {η}^{*} ( {n}_{1} ) {w}^{*} ( {n}_{1} ) ) ( h ( {n}_{2} ) s ( {n}_{2} ) w ( {n}_{2} ) + η ( {n}_{2} ) w ( {n}_{2} ) ) ( {h}^{*} ( {n}_{2} ) {s}^{*} ( {n}_{2} ) {w}^{*} ( {n}_{2} ) + {η}^{*} ( {n}_{2} ) {w}^{*} ( {n}_{2} ) ) )}^{2}$$

By solving the equation before and considering a similar approach for hypotheses H₁:

$${{σ}_{h 1}}^{2} = \frac{{{E}_{w}}^{2}}{{N}^{2}} {( {σ}_{η}^{2} + {σ}_{s}^{2} )}^{2} \qquad Eq . ( 15 )$$

By using Eq. (15), is possible to compute the standard deviation for hypotheses H₁, i.e. σₕ₁, as follows:

$${σ}_{h 1} = \sqrt{{σ}_{h 1}^{2}} \qquad Eq . ( 16 )$$

$${σ}_{h 1} = \frac{{E}_{w}^{2}}{{N}^{2}} {( {σ}_{η}^{2} + {σ}_{s}^{2} )}^{2}$$

$${σ}_{h 1} = \frac{{E}_{w}}{N} \sqrt{{( {σ}_{η}^{2} + {σ}_{s}^{2} )}^{2}}$$

$${σ}_{h 1} = \frac{{E}_{w}}{N} {σ}_{η}^{2} ( 1 + γ )$$

Considering Eq. (13) and Eq. (15), the number of spectrum sensing procedures L of the interest channel can also be computed, as follows:

$${σ}_{h 1}^{2} = \frac{{E}_{w}^{2}}{{N}^{2}} {( {σ}_{n}^{2} + {σ}_{s}^{2} )}^{2} * \frac{1}{L} \qquad Eq . ( 17 )$$

The noise variance of a mobile user is directly proportional to the sampling rate fₛ, of an ADC. The classic theory of spectrum sensing does not consider key factors, for instance: neither the sampling rate value nor the characteristic of the quantization level of an ADC. It's essential to recall that the noise floor in the discrete time domain is dependent on the sampling rate value defined by the ADC. Therefore, is necessary to consider for the formulation of a spectrum sensing algorithm both sampling rate fₛ and quantization level without considering quantization error q=2^{b}, whererin b=number of bits

Given the analysis, the noise variance is given by:

$${σ}_{η}^{2} = {{σ}_{η} ( {f}_{s} q )}^{2} \qquad Eq . ( 18 )$$

It is important to define a parameter that can characterize the switching time for the interest channel and the sample collection time. This time is known as dwell delay time T_{d} that requires to be set to at least a few seconds to guarantee that the samples of the frequency of interest are collected during the spectrum sensing stage.

Therefore, considering the spectrum sensing time, the quantization time and the quantization error, the dwell delay time T_{d} is given as follows:

$${T}_{d} = \frac{NL}{{f}_{s}} + \frac{NL}{{2}^{2 b}} \qquad Eq . ( 19 )$$

$${T}_{d} = \frac{NL ( {f}_{s} + {2}^{2 b} )}{{f}_{s} {2}^{2 b}}$$

wherein N is the number of the received samples by the ADC of the mobile user, L is the number of spectrum sensing procedures of an interest channel, fₛ is ADC sampling rate value, b is the number of bits of the quantizer.

The error of the variance of noise along the quantization stage is given by:

$${σ}_{ϵ}^{2} = {\int }_{\frac{Δ}{2}}^{- \frac{Δ}{2}} {ϵ}^{2} [ n ] {f}_{ϵ} ( x ) d ϵ$$

wherein Δ corresponds to the dynamic range of the quantizer, q is the quantization levels without considering the error of quantization, i.e. q=2^{b}. Then:

$$Δ = \frac{{v}_{max}}{q}$$

Since f_{∈}(x), is given by:

$${f}_{ϵ} ( x ) = \{ \begin{matrix}\frac{1}{b - a} ∀ a \leq x \leq b \\ 0\end{matrix}$$

Therefore, is possible to conclude that:

$${σ}_{ϵ}^{2} = {\int }_{- \frac{Δ}{2}}^{\frac{Δ}{2}} {ϵ}^{2} [ n ] {f}_{ϵ} ( x ) d ϵ = {\int }_{- \frac{Δ}{2}}^{\frac{Δ}{2}} {ϵ}^{2} [ n ] ( \frac{1}{\frac{Δ}{2} + \frac{Δ}{2}} ) d ϵ$$

$${σ}_{ϵ}^{2} = {\int }_{- \frac{Δ}{2}}^{\frac{Δ}{2}} {ϵ}^{2} [ n ] ( \frac{1}{Δ} ) d ϵ$$

$${σ}_{ϵ}^{2} = \frac{1}{Δ} {\int }_{- \frac{Δ}{2}}^{\frac{Δ}{2}} {ϵ}^{2} [ n ] d ϵ$$

$${σ}_{ϵ}^{2} = \frac{1}{Δ} \cdot \frac{{ϵ}^{3} [ n ]}{3} {\vert}_{- \frac{Δ}{2}}^{\frac{Δ}{2}}$$

$${σ}_{ϵ}^{2} = \frac{1}{3 Δ} \cdot \frac{{Δ}^{3} + {Δ}^{3}}{8}$$

$${σ}_{ϵ}^{2} = \frac{1}{3 Δ} \cdot \frac{2 {Δ}^{3}}{8}$$

$${σ}_{ϵ}^{2} = \frac{{Δ}^{2}}{12}$$

Substituting the value of Δ, then:

$${σ}_{ϵ}^{2} = \frac{{( \frac{{v}_{max}}{q} )}^{2}}{12}$$

$${σ}_{ϵ}^{2} = \frac{{V}_{max}^{2}}{12 {q}^{2}}$$

$${σ}_{ϵ}^{2} = \frac{1}{12} \frac{{V}_{max}^{2}}{{2}^{2 b}}$$

$${σ}_{ϵ}^{2} = \frac{{V}_{max}^{2}}{{2}^{2 n} 12} ≡ \frac{{2}^{- 2 n} {V}_{max}}{12}$$

As shown in Eq. (19), to consider the power consumption of the ADC during the dwell delay time (T_{d}) of the number of N samples in the L spectrum sensing of the interest channel, it is essential to consider the factor: 2²ⁿ12 of σ_{∈}².

Defining equations Eq. (5), Eq. (6), Eq. (9), Eq. (13), Eq. (14), Eq. (15), Eq. (17), Eq. (18), Eq. (19), is possible to compute:
probability to correctly detect an occupied channel (P_{d}).
probability not to detect properly a vacant channel (P_{f});
probability not to detect properly an occupied channel (Pₘ); and
threshold value to define if the interest channel is occupied or not (λ).

### Probability of Detection (P_{d})

Considering the case for gaussian random variable, which density probability function is a gaussian distribution ˜N(μ, σ²) for the probability to correctly detect an occupied channel P_{d}.

For the hypotheses H₁:

$${P}_{d} = P \{ V > λ \vert {H}_{1} \} = Q ( \frac{λ - μ}{σ} )$$

where λ is the threshold.

Then, by substituting:

$${P}_{d} = P \{ V > λ \vert {H}_{1} \} = Q ( \frac{λ - \frac{{E}_{w} {{σ}_{η} ( {f}_{s} q )}^{2}}{N} ( 1 + γ )}{{E}_{w} {{σ}_{η} ( {f}_{s} q )}^{2} ( 1 + γ )} \frac{{2}^{2 b}}{( {2}^{2 b} + {f}_{s} )} \frac{{T}_{d} {f}_{s}}{\sqrt{L}} ) \qquad Eq . ( 20 )$$

wherein

$$γ = \frac{{σ}_{s}^{2}}{{σ}_{η}^{2}}$$

given by Eq. (14).

### Probability of False Alarm (P_{f})

Considering the case for gaussian random variable which density probability function is a gaussian distribution ˜N(μ, σ²) for the probability to not correctly detect a vacant channel P_{f}. In addition, using the statistics value of μ and σ previously computed.

For the hypotheses H₀:

$${P}_{f} = P \{ V > λ \vert {H}_{0} \} = Q ( \frac{λ - μ}{σ} )$$

where λ is the threshold.

Then by substituting:

$${P}_{f} = P \{ V > λ \vert {H}_{0} \} = Q ( \frac{( λ - \frac{{E}_{w} {{σ}_{η} ( {f}_{s} q )}^{2}}{N} )}{{E}_{w} {{σ}_{η} ( {f}_{s} q )}^{2}} \frac{{2}^{2 b}}{( {2}^{2 b} + {f}_{s} )} \frac{{T}_{d} {f}_{s}}{\sqrt{L}} ) \qquad Eq . ( 21 )$$

### Probability of Miss-Detection (Pₘ)

Using Eq. (20), is possible to compute probability not to detect properly an occupied channel Pₘ, given by:

$${P}_{m} = P \{ V < λ \vert {H}_{1} \} = 1 - {P}_{d} \qquad Eq . ( 22 )$$

$${P}_{m} = P \{ V < λ \vert {H}_{1} \} = 1 - Q ( \frac{λ - \frac{{E}_{w} {{σ}_{η} ( {f}_{s} q )}^{2}}{N} ( 1 + γ )}{{E}_{w} {{σ}_{η} ( {f}_{s} q )}^{2} ( 1 + γ )} \frac{{2}^{2 b}}{( {2}^{2 b} + {f}_{s} )} \frac{{T}_{d} {f}_{s}}{\sqrt{L}} )$$

### Threshold (λ)

To obtain the threshold, we can use Eq. (20) or Eq. (21). Considering Eq. (20) as a constant P_{f} value. Then:

$${λ}_{S} = \frac{{Q}^{- 1} ( {P}_{f} ) \sqrt{L}}{\frac{{2}^{2 b}}{{( {2}^{2 b} + {f}_{s} )}^{{T}_{d} {f}_{s}}}} {{σ}_{η} ( {f}_{s} q )}^{2} {E}_{w} + {{σ}_{η} ( {f}_{s} q )}^{2} \frac{{E}_{w}}{N} \qquad Eq . ( 23 )$$

It's important to recall that Eq. (20) to Eq. (23) consider the noise variance of a mobile user is directly proportional to the sampling rate fₛ, of an ADC. The classic theory of spectrum sensing does not consider key factors, for instance: neither the sampling rate value nor the characteristic of the quantization level of an ADC. It's essential to recall that the noise floor in the discrete time domain is dependent on the sampling rate value defined of the ADC. Therefore, it's necessary consider for the formulation of a spectrum sensing algorithm both the sampling rate fₛ, and the quantization level also consider the quantization error qe=2^{2b}; where: b=number of bits.

### Cooperative Spectrum Sensing (CSS)

Considering a centralized network configuration which uses a server to store mobile user local spectrum sensing decision, is possible to define the following hard combining algorithm: the AND, and the OR rules.

AND algorithm: the mobile user decides if a primary signal is present if all mobile users have detected the primary user in the interest channel.

$$\begin{matrix}{Q}_{f A} = {\prod }_{i = 1}^{R} {P}_{f} ( {A}_{r i} ) \\ {Q}_{d A} = {\prod }_{i = 1}^{R} {P}_{d} ( {A}_{r i} ) \\ {Q}_{m A} = 1 - {\prod }_{i = 1}^{R} {P}_{d} ( {A}_{r i} )\end{matrix}$$

wherein Aᵣᵢ corresponds to the local spectrum sensing result done by the device

OR algorithm: the mobile user decides if a primary signal is present if at least one mobile user has detected the primary user in the interest channel.

$$\begin{matrix}{Q}_{f R} = 1 - {\prod }_{i = 1}^{R} ( 1 - {P}_{f} ( {A}_{r i} ) ) \\ {Q}_{d R} = 1 - {\prod }_{i = 1}^{R} ( 1 - {P}_{d} ( {A}_{r i} ) ) \\ {Q}_{m R} = 1 - ( 1 - {\prod }_{i = 1}^{R} ( 1 - {P}_{d} ( {A}_{r i} ) ) )\end{matrix}$$

wherein Aᵣᵢ corresponds to the local spectrum sensing result done by the device.

Eq. (20) to Eq. (23) consider the noise variance of a mobile user is directly proportional to the sampling rate fₛ, of an ADC. The classic theory of spectrum sensing does not consider key factors, for instance: neither the sampling rate value nor the characteristic of the quantization level of an ADC. It's essential to recall that the noise floor in the discrete time domain is dependent of the sampling rate value defined of the ADC. Therefore, it's necessary consider for the formulation of a spectrum sensing algorithm both the sampling rate fₛ, and the quantization level also consider the quantization error qe=2^{2b}; wherein b=number of bits.

The simulation scenario considered both a single sensing (SS) network and a cooperative spectrum sensing (CSS) configuration. A total number of 256 bins were considered, different values of dwell delay time were computed as well as bits values of the quantizer were evaluated from 10 bits to 18 bits. In addition, the number of spectrum sensing L are above 1 and a P_{f}=0.1 was considered.

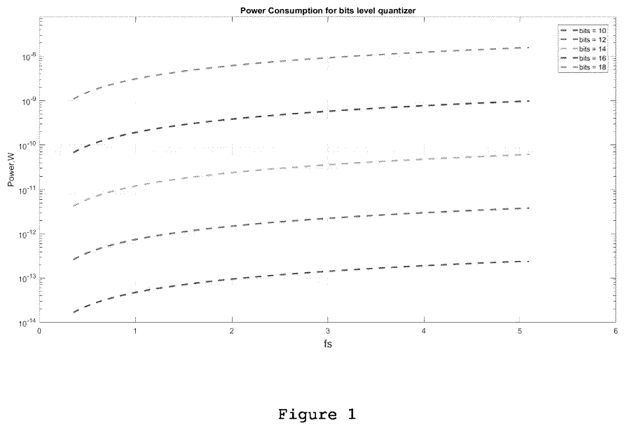

FIG. 1 shows the power consumption in Watts as a function of the sampling rate values of a device. As we can observe, there is a relationship among the power consumption, the quantizer bit level and the sampling rate. The higher the bit of the dynamic range is, the higher the power consumption is. Additionally, as the sampling rate increases, the power consumption increases too. Therefore, the proposed method can offer the trade-off among the power consumption, the quantizer bit level and the sampling rate which main goal is to obtain the highest probability of detection P_{d}.

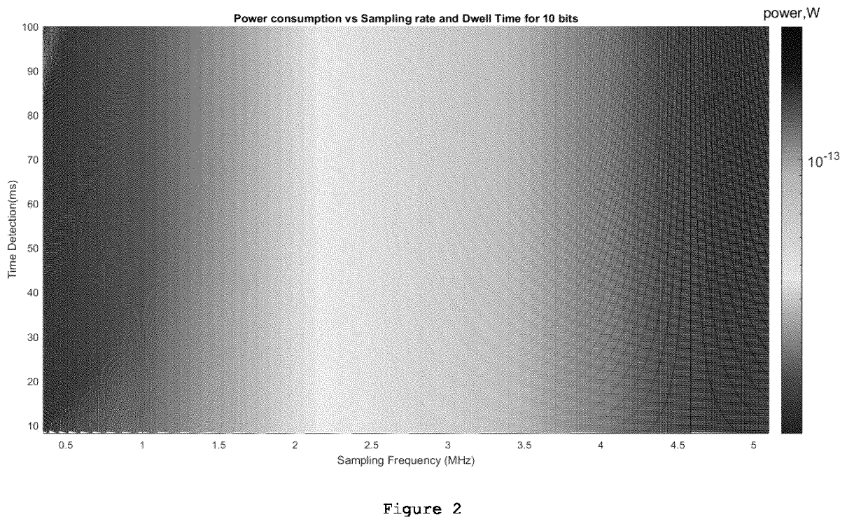

FIG. 2 illustrates the power consumption in Watts for a 10-bits ADC as function of the sampling rate values of a device and the detection time in milliseconds during the spectrum sensing stage. As we can observe, the higher the sampling rate fₛ is, the higher the power consumption is. In addition, as expected, there is a tradeoff between the detection time (milliseconds) and the power consumption expressed in Watt.

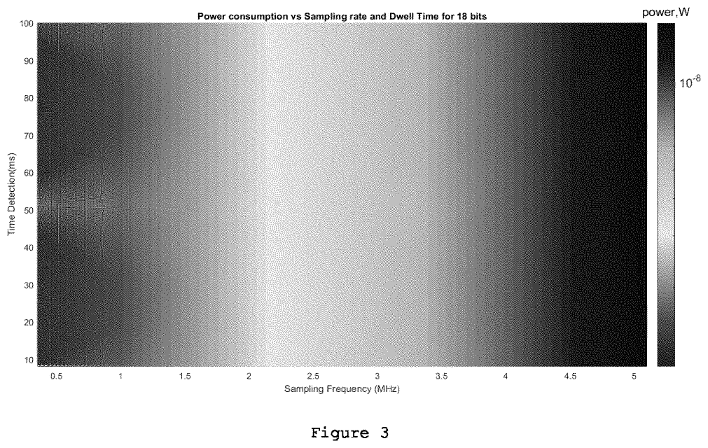

FIG. 3 presents the power consumption in Watts for an 18-bits ADC as function of the sampling rate values of a device and the detection time in milliseconds during the spectrum sensing stage. As we can observe, the higher the sampling rate fₛ is, the higher the power consumption is. In addition, as expected, there is a tradeoff between the detection time (milliseconds) and the power consumption expressed in Watt. Nevertheless, if we compare the power consumption between FIG. 2 and FIG. 3, an 18-bit ADC presents a higher power consumption as shown in FIG. 1.

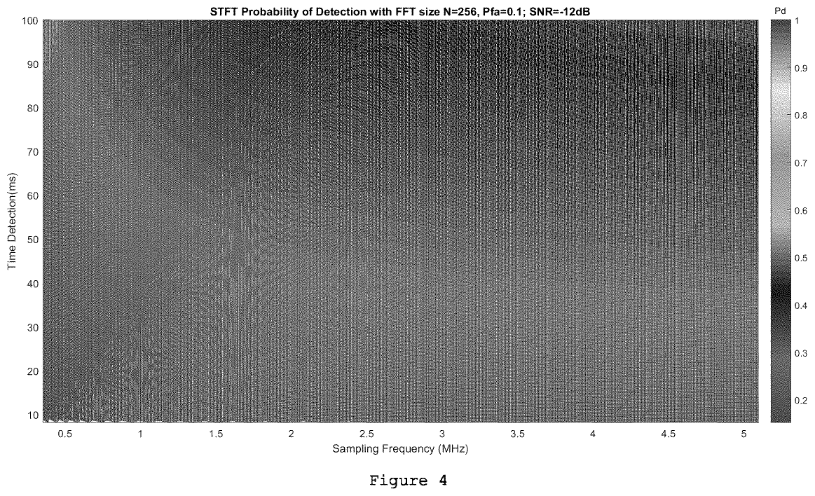

FIG. 4 shows the results for a 10-bit ADC and single spectrum sensing case for the probability of detection P_{d} as a function of detection time, number of bits of the quantizer and the sampling rate fₛ of a device. The highest probability of detection is obtained using lower sampling frequency (red color) for a single spectrum sensing scenario but with the worst probability of detection P_{d} value. In addition, the highest probability of detection is between 40-50% (blue color) for a single sensing scenario. This method considers the levels of the quantizer as a function of the ADC bits, therefore, a trade-off between power consumption and sampling rate should be considered in order to get a higher probability of detection P_{d}.

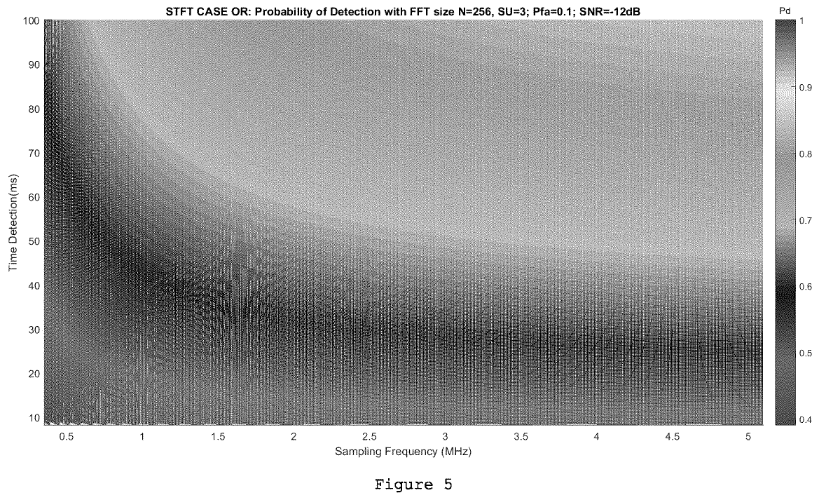

FIG. 5 shows the results for a 10-bit ADC and cooperative spectrum sensing case using three mobile users for the probability of detection P_{d} as a function of detection time, number of bits of the quantizer and the sampling rate fₛ of a device for the OR rule. As we can observe, the highest probability of detection is obtained using higher sampling frequency (green color) for a cooperative spectrum sensing scenario and using OR rule. This method considers the ADC bits and the power consumption, therefore, a trade-off among the power consumption, detection time and sampling rate should be considered.

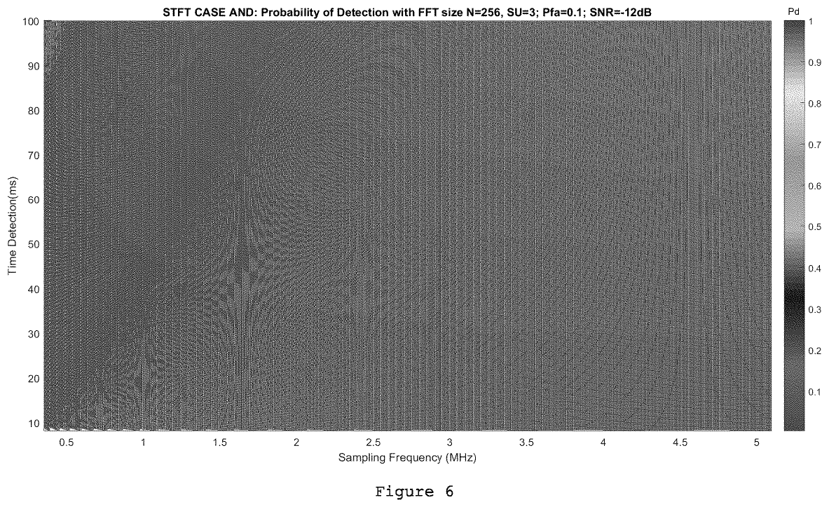

FIG. 6 shows the results for a 10-bit ADC and cooperative spectrum sensing case using three mobile users for the probability of detection P_{d} as a function of detection time, number of bits of the quantizer and the sampling rate fₛ of a device for the AND rule. As we can observe, considering the AND rule in a cooperative spectrum sensing and using a 10 bit ADC just a probability of detection P_{d} between 10-20% can be computed.

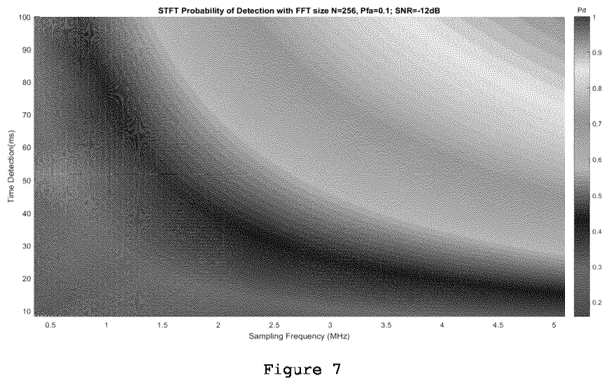

FIG. 7 shows the results for an 18-bit ADC and single spectrum sensing case for the probability of detection P_{d} as a function of detection time, number of bits of the quantizer and the sampling rate fₛ of a device. Using an 18 bit ADC offers a much better performance in comparison to a 10 bit ADC. Since, we can observe that the probability of detection P_{d} is higher and above 80% of probability to correctly detect an occupied channel (yellow and orange colors). This method considers the levels of the quantizer as a function of the ADC bits (as shown in FIG. 1), therefore, a trade-off between power consumption and sampling rate should be considered in order to get a higher probability of detection P_{d}.

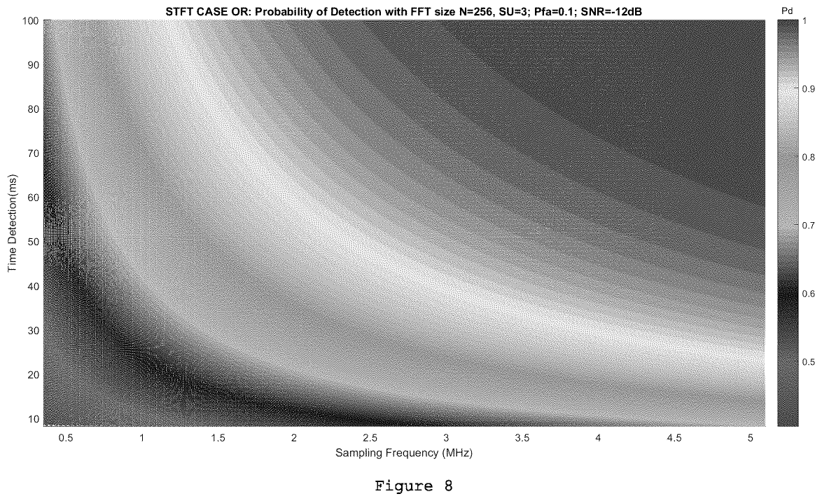

FIG. 8 shows the results for an 18-bit ADC and cooperative spectrum sensing case using three mobile users for the probability of detection P_{d} as a function of detection time, number of bits of the quantizer and the sampling rate fₛ of a device for the OR rule. Using an 18-bit ADC offers a much better performance in comparison to a 10 bit ADC. This result clearly shows an improvement of the computation of P_{d} since, the values are above 90% (yellow and orange color) using sampling frequency fₛ above 2 MHz and a detection time equal to 60 ms. As mentioned before, depending on the scenario of interest, power consumption and a sampling rate analysis should be considered as shown in FIG. 1.

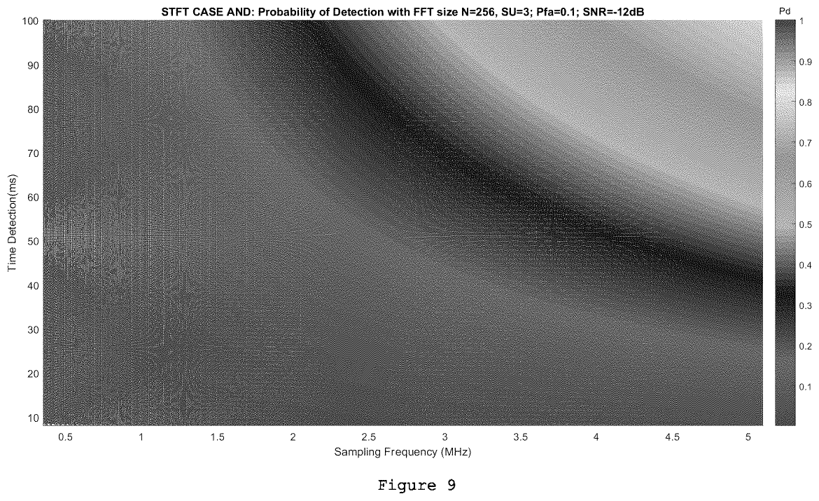

FIG. 9 shows the results for an 18-bit ADC and cooperative spectrum sensing case using three mobile users for the probability of detection P_{d} as a function of detection time, number of bits of the quantizer and the sampling rate fₛ of a device for the AND rule. Comparing these results with FIG. 6, we can observe an improvement of the method since an 18 bit ADC is used to correctly detect an occupied channel. The highest values are between 60% and 80%.

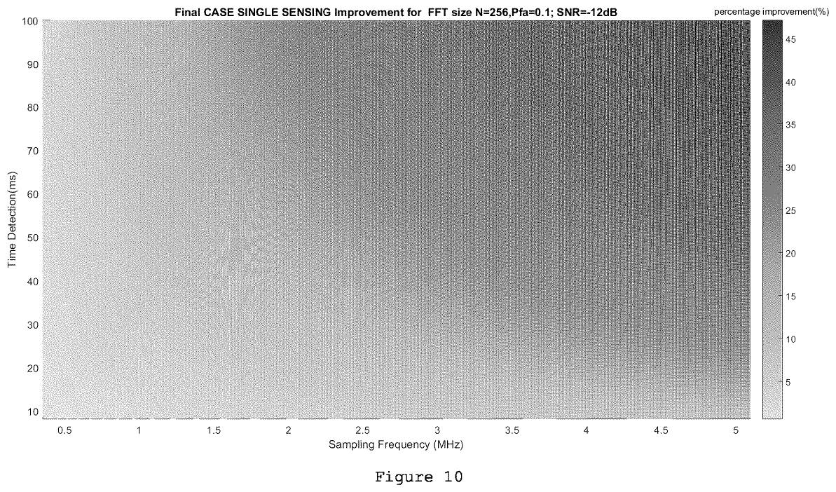

FIG. 10 compares the results between a 10-bit ADC and an 18-bit ADC considering a single spectrum sensing case for the probability of detection P_{d} as a function of detection time, number of bits of the quantizer and the sampling rate fₛ of a device. The purpose of this comparison is to show how to choose a much better ADC can influence in the performance of a probability of detection P_{d}. Since, a 45% of improvement was obtained for the single spectrum sensing case (blue color) when using higher sampling rate fₛ.

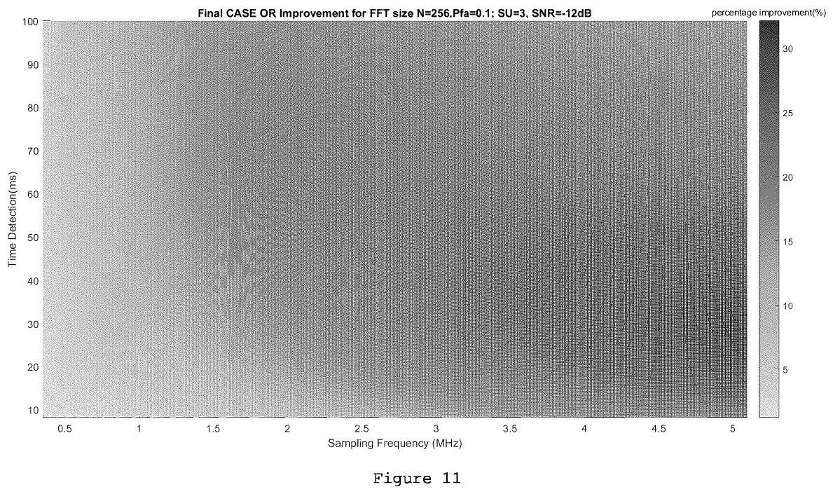

FIG. 11 compares the results between a 10-bit ADC and an 18-bit ADC considering a cooperative spectrum sensing case for the probability of detection P_{d} as a function of detection time, number of bits of the quantizer and the sampling rate fₛ of a device for OR rule. The purpose of this comparison is to show how to choose a much better ADC can influence in the performance of a probability of detection P_{d}. Since, a 30% of improvement was obtained for the single spectrum sensing case (blue color) when using higher sampling rate fₛ.

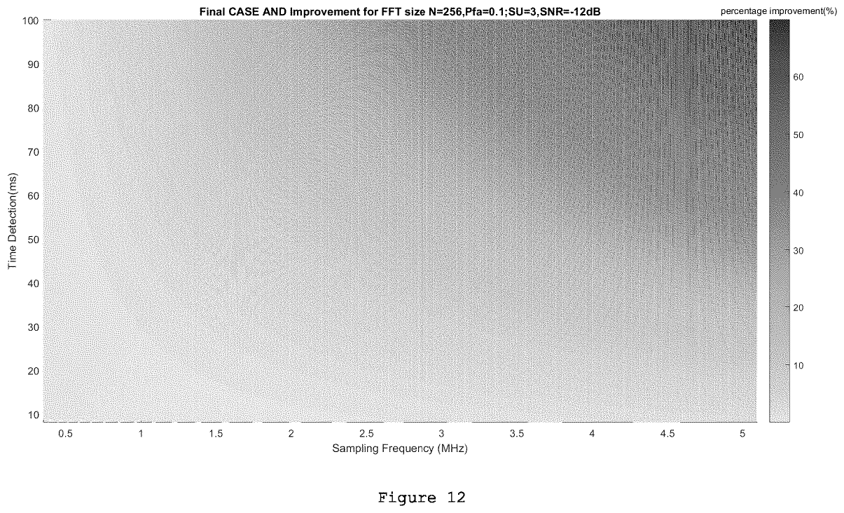

FIG. 12 compares the results between a 10-bit ADC and an 18-bit ADC considering a cooperative spectrum sensing case for the probability of detection P_{d} as a function of detection time, number of bits of the quantizer and the sampling rate fₛ of a device for AND rule. The purpose of this comparison is to show how to choose a much better ADC can influence in the performance of a probability of detection P_{d}. Since, a 60% of improvement was obtained for the single spectrum sensing case (blue color) when using higher sampling rate fₛ (As shown also in FIG. 9).

Eq. (20) to Eq. (23) consider the noise variance of a mobile user is directly proportional to the sampling rate fₛ, of an ADC. The classic theory of spectrum sensing does not consider key factors, for instance: neither the sampling rate value nor the characteristic of the quantization level of an ADC. It's essential to recall that the noise floor in the discrete time domain is dependent of the sampling rate value defined of the ADC. Therefore, it's necessary consider for the formulation of a spectrum sensing algorithm both the sampling rate fₛ, and the quantization level also consider the quantization error qe=2^{2b}; wherein b=number of bits.

The simulation scenario considered both a single sensing (SS) network and a cooperative spectrum sensing (CSS) configuration. A total number of 256 bins were considered, different values of dwell delay time were computed as well as bits values of the quantizer were evaluated from 10 bits to 18 bits. In addition, the number of spectrum sensing L are above 1 and a P_{f}=0.1 was considered.

Although the present invention has been described in connection with certain preferred embodiments, it should be understood that is not intended to limit the disclosure to those particular embodiments. Rather, it is intended to cover all alternatives, modifications and equivalents possible within the spirit and scope of the disclosure as defined by the appended claims.

What is claimed is:

1. A method of cooperative spectrum sensing for Cognitive Radio (CR) device, the method comprising:
computing and providing:
a trade-off among baseband sampling (fₛ);
a mobile user spectrum sensing duration time (t_{d});
a probability to correctly detect an occupied channel (P_{d});
dynamic power consumption values considering technical capabilities of an analog-to-digital converters (ADC) in relation to a number of bit resolution levels; and
a probability of false alarm (P_{f}).

2. The method as in claim 1, wherein energy detection is computed in both a time domain and a frequency domain and a received sample signal x[n] is expressed as follows:
x[n]=hs[n]+η[n],
wherein x[n] is the received sample signal, s[n] is a transmitted signal, h is a complex gain of an ideal channel, n is an AWGN noise and n is a sample index in a case of sensing in the time domain or symbol index for sensing in the frequency domain.

3. The method as in claim 1, wherein a spectrum sensing problem is formulated by a vacant channel H₀ or an occupied channel H₁, wherein both hypotheses are described as follows:
$$\begin{matrix}{H}_{0} : {x}_{r} ( n ) = {η}_{r} ( n ) & ; 1 < n < 2 t w \\ {H}_{1} : {x}_{r} ( n ) = {h}_{r} s ( n ) + {η}_{r} ( n ) & ; 1 < n < 2 t w\end{matrix}$$
wherein xᵣ(n) represents a received complex sample signal for r^{th} users, s(n) is a sample of a transmitted signal at sampling instant
$${t}_{n} = \frac{n}{2 w} ,$$
ηᵣ(n) is a sample of an AWGN noise received by r^{th} CR user at sampling instant
$${t}_{n} = \frac{n}{2 w} .$$

4. The method as in claim 1, wherein a spectrum sensing is computed using a high number of N received samples, a statistic test for each mobile user r is defined by using energy of received samples such as xᵣ(n)=Vᵣ=Eᵣ,
wherein, a summation of all the spectrum sensing using the high number of N received samples and the statistic test for each mobile user r is computed as follows:
$${x}_{r} ( n ) = {V}_{r} = {E}_{r} = \frac{1}{N} {\sum }_{n = 1}^{N = 2 tw} {x ( n )}^{2} \begin{matrix}{>}^{{H}_{1}} \\ < {H}_{0}\end{matrix} λ .$$

5. The method as in claim 1, wherein considering a Short-Time Fourier Transform and a time domain approach, for each of r mobile user, a spectrum sensing is defined as follows:
$${x}_{r} ( n ) = {V}_{r} = {E}_{r} = \frac{1}{N} {\sum }_{n = 1}^{N = 2 t w} {\vert x ( n ) w ( n ) \vert}^{2} .$$

6. The method as in claim 1, wherein a number of spectrum sensing procedures L of an interest channel is computed as follows:
$${T}_{r} = V = E = \frac{1}{L} {\sum }_{m = 1}^{L} {T}_{m} .$$

7. The method as in claim 1, wherein provided an algorithm of spectrum sensing increases a number of spectrums sensing L of an interest channel, a variance for hypotheses H₀ decreases as function of the L factor.

8. The method as in claim 1, wherein a noise variance of a mobile user is directly proportional to a sampling rate fₛ, of an ADC, and the noise variance is calculated by:
σ_{η}²=σ_{η}(fₛq)².

9. The method as in claim 1, wherein considering a spectrum sensing time, a quantization time and a quantization error, a dwell delay time T_{d} is calculated by:
$${T}_{d} = \frac{N L ( {f}_{s} + {2}^{2 b} )}{{f}_{s} {2}^{2 b}}$$
wherein N is a number of received samples by the ADC of a mobile user, L is a number of spectrum sensing procedures of an interest channel, fₛ is ADC sampling rate value, b is a number of bits of a quantizer.

10. The method as in claim 1, wherein statistics metrics of an energy detector are defined as follows:
the probability to correctly detect the occupied channel (P_{d}) is a function of the dynamic power consumption values considering technical capabilities of the ADC as a relation of a number of bits levels of resolution; the probability of false alarm (P_{f}) which is a probability not to detect properly a vacant frequency;
the probability of missed detection (Pₘ) which is the probability not to detect properly an occupied frequency; and
a threshold value λ.

11. The method as in claim 10, wherein the probability to correctly detect the occupied channel (P_{d}) is calculated by:
$${P}_{d} = P \{ V > λ \vert {H}_{1} \} = Q ( \frac{λ - \frac{{E}_{w} {{σ}_{η} ( {f}_{s} q )}^{2}}{N} ( 1 + γ )}{{E}_{w} {{σ}_{η} ( {f}_{s} q )}^{2} ( 1 + γ )} \frac{{2}^{2 b}}{( {2}^{2 b} + {f}_{s} )} \frac{{T}_{d} {f}_{s}}{\sqrt{L}} )$$
Wherein
$$γ = \frac{{σ}_{s}^{2}}{{σ}_{η}^{2}} .$$

12. The method as in claim 10, wherein the probability of false alarm (P_{f}) is calculated by:
$${P}_{f} = P \{ V > λ \vert {H}_{0} \} = Q ( \frac{( λ - \frac{{E}_{w} {{σ}_{η} ( {f}_{s} q )}^{2}}{N} )}{{E}_{w} {{σ}_{η} ( {f}_{s} q )}^{2}} \frac{{2}^{2 b}}{( {2}^{2 b} + {f}_{s} )} \frac{{T}_{d} {f}_{s}}{\sqrt{L}} ) .$$

13. The method as in claim 10, wherein the probability of missed detection (Pₘ) is calculated by:
$${P}_{m} = P \{ V < λ \vert {H}_{1} \} = 1 - Q ( \frac{λ - \frac{{E}_{w} {{σ}_{η} ( {f}_{s} q )}^{2}}{N} ( 1 + γ )}{{E}_{w} {{σ}_{η} ( {f}_{s} q )}^{2} ( 1 + γ )} \frac{{2}^{2 b}}{( {2}^{2 b} + {f}_{s} )} \frac{{T}_{d} {f}_{s}}{\sqrt{L}} ) .$$

14. The method as in claim 10, wherein the threshold (λ) is calculated by:
$${λ}_{S} = \frac{{Q}^{- 1} ( {P}_{f} ) \sqrt{L}}{\frac{{2}^{2 b}}{( {2}^{2 b} + {f}_{s} )} {T}_{d} {f}_{s}} {{σ}_{η} ( {f}_{s} q )}^{2} {E}_{w} + {{σ}_{η} ( {f}_{s} q )}^{2} \frac{{E}_{w}}{N} .$$

15. The method as in claim 1, wherein a mobile user decides whether a primary signal is present upon all mobile users having detected a primary user on a channel of interest.

16. The method as in claim 1, wherein a mobile user decides whether a primary signal is present upon at least one mobile user having detected a primary user in an interest channel.
